(19) United States
(12) Patent Application Publication
(10) Pub. No.: US 2007/0268799 A1
(43) Pub. Date: Nov. 22, 2007

(54) DEMODULATION METHOD FOR MAGNETIC DATA

(75) Inventor: Yasuhiro Kitazawa, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: NIDEC Sankyo Corporation

(21) Appl. No.: 11/746,146

(22) Filed: May 9, 2007

(30) Foreign Application Priority Data
May 22, 2006 (JP) 2006-141778

(51) Int. Cl. G11B 20/10

(52) U.S. Cl. 369/47.28

(57) ABSTRACT

A demodulation method for magnetic data may include the steps of reading magnetic data with a magnetic head, generating a digital signal from a read analog signal, comparing an inversion time interval of the digital signal with a bit reference time interval, and generating bit data on the basis of comparing result of the digital signal. This demodulation method for magnetic data may further include a first step of comparing the inversion time interval of the digital signal with a bit lacking reference time interval which is set to be longer than the bit reference time interval, and a second step of discontinuing generation of the bit data when the inversion time interval of the digital signal is detected to be longer than the bit lacking reference time interval in the first step.

### CROSS REFERENCE TO RELATED APPLICATION

The present invention claims priority under 35 U.S.C. §119 to Japanese Application No. 2006-141778 filed May 22, 2006, which is incorporated herein by reference.

### BACKGROUND OF THE INVENTION

a) Field of the Invention

The present invention relates to a demodulation method for magnetic data in which magnetic data recorded on a magnetic recording media are read by using a magnetic head to be demodulated.

b) Description of the Related Art

For a commonly used magnetic recording system in a magnetic data reading device such as a magnetic card reader, an FM modulation system has been known in which binary magnetic data with a combination of two kinds of frequency of “F” and “2F” are recorded on a magnetic recording media. When magnetic data recorded by the FM modulation system are read out, a magnetic head is relatively slid on a magnetic stripe on the magnetic recording media to reproduce magnetic data as an analog signal and then the analog signal is converted into a digital signal to be taken into a CPU (see, for example, Japanese Patent Laid-Open No. Hei 8-31112).

The CPU stores inverted time intervals of the digital signal which is taken into the CPU in a memory as time data. The time data are compared with reference data in conformity to recording characteristics in a track on the magnetic stripe and, when the time data are larger than the reference data, the data are judged as the bit “0” and, when the time data are smaller than the reference data, the data are judged as the bit “1”. As a result, bit data (data string) consisting of “1” and “0” are formed. After that, data characters recorded in the track in the magnetic stripe are formed from the bit data and then error detection for the data characters which have been formed is performed to determine the read magnetic data to be right or wrong.

However, when bit data are generated on the basis of time data, for example, in a case that data on the magnetic stripe include a demagnetized portion, the time data become larger than the reference data and thus the time data are determined to be the bit “0”. When bit data including this wrong bit “0” are determined as correct by the error detection, incorrect determination may be resulted that data of the track in the magnetic stripe are correctly read out even when they actually include wrong bit data.

### OBJECT AND SUMMARY OF THE INVENTION

In view of the problems described above, it is an object of the present invention to advantageously provide a demodulation method for magnetic data which is capable of preventing an incorrect judgment when data in a magnetic recording medium include a demagnetization portion and, as a result, which is capable of enhancing demodulation accuracy.

Thus, according to an embodiment of the present invention, there may be provided a demodulation method for magnetic data as described below.

A demodulation method for magnetic data comprising the steps of:
reading magnetic data recorded on a magnetic recording medium with a magnetic head to produce an analog signal;
generating a digital signal from the analog signal;
comparing an inversion time interval of the digital signal with a bit reference time interval; and
generating bit data on a basis of comparing result of the digital signal;
wherein the demodulation method for magnetic data further comprises:
a first step of comparing the inversion time interval of the digital signal with a bit lacking reference time interval which is set to be longer than the bit reference time interval, and
a second step of discontinuing generation of the bit data when the inversion time interval of the digital signal is detected to be longer than the bit lacking reference time interval in the first step.

According to the invention, in a demodulation method for magnetic data including the steps of reading magnetic data recorded on a magnetic recording medium with a magnetic head to produce an analog signal; generating a digital signal from the analog signal; comparing an inversion time interval of the digital signal with a bit reference time interval; and generating bit data on a basis of comparing result of the digital signal, the inversion time interval of the digital signal is compared with a bit lacking reference time interval which is set to be longer than the bit reference time interval and, when the inversion time interval of the digital signal is longer than the bit lacking reference time interval in the first step, generation of the bit data is discontinued. As a result, demodulation accuracy can be enhanced.

In other words, in the conventional demodulation method, when data on a magnetic stripe include, for example, a demagnetized portion to cause incorrect bit data to be generated, the bit data may be judged to be correct depending on a kind of error detection and, as a result, incorrect judgment may be obtained that data on the track are correctly read out. However, according to the present invention, even when data on a magnetic stripe include a demagnetized portion, generation of bit data is discontinued at the time when an inversion time interval of a digital signal is detected to be longer than the predetermined bit lacking reference time interval. Therefore, incorrect judgment, i.e., generation of abnormal bit data are prevented and thus demodulation accuracy can be enhanced. Further, when generation of abnormal bit data is prevented in a demodulation process of magnetic data, processing time can be reduced.

In the inventive method described above, it is preferable that the first step and/or the second step is executed before the inversion time interval of the digital signal is compared with the bit reference time interval.

According to an aspect of the inventive method, the first step and/or the second step is executed before the inversion time interval of the digital signal is compared with the bit reference time interval. Therefore, waste of generating bit data based on a digital signal including bit lacking (incorrect digital signal) is prevented.

In the inventive method described above, it is preferable that, when the inversion time interval of the digital signal is detected to be shorter than the bit lacking reference time interval in the first step, the inversion time interval of the digital signal is compared with the bit reference time interval.

According to an aspect of the inventive method described above, when the inversion time interval of the digital signal is detected to be shorter than the bit lacking reference time interval in the first step, the inversion time interval of the digital signal is compared with the bit reference time interval. Therefore, when the inversion time interval of the digital signal is shorter than the bit lacking reference time interval in the first step, bit data are generated as the digital signal is considered to be normal without having bit lacking and thus correct bit data are generated.

In the inventive method described above, it is preferable that the bit lacking reference time interval is set to be about 1.5 times of a time interval which corresponds to a bit “0”. Further, it is preferable that the bit lacking reference time interval is set to be capable of detecting a demagnetized portion of data on a magnetic stripe.

According to an aspect of the inventive method described above, the bit lacking reference time interval is set to be about 1.5 times of a time interval which corresponds to a bit “0”. Therefore, a preferable bit lacking reference time interval is established as a condition for discontinuing generation of bit data.

Other features and advantages of the invention will be apparent from the following detailed description, taken in conjunction with the accompanying drawings that illustrate, by way of example, various features of embodiments of the invention.

Embodiments will now be described, by way of example only, with reference to the accompanying drawings which are meant to be exemplary, not limiting, and wherein like elements are numbered alike in several figures.

### BRIEF DESCRIPTION OF THE DRAWINGS

In the drawings:

FIGS. 1(a) and 1(b) are explanatory views showing a mechanical and electrical structure of a magnetic data reading device for performing a demodulation method for magnetic data in accordance with an embodiment of the present invention;

FIG. 2 is a flow chart for explaining a demodulation method for magnetic data in accordance with an embodiment of the present invention; and

FIGS. 3(a) through 3(i) are explanatory views for explaining a demodulation method for magnetic data in accordance with an embodiment of the present invention.

### DESCRIPTION OF THE PREFERRED EMBODIMENTS

An embodiment of the present invention will be described below with reference to the accompanying drawings.

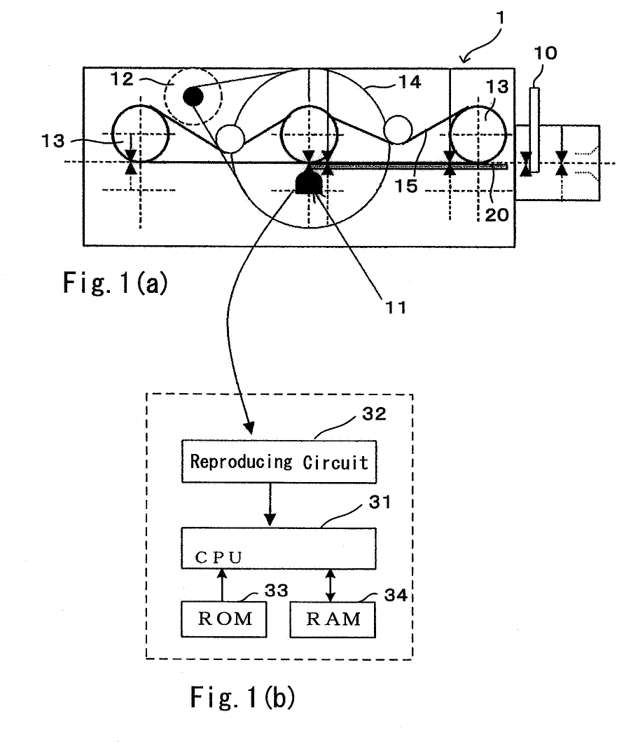

FIGS. 1(a) and 1(b) are explanatory views showing a mechanical and electrical structure of a magnetic data reading device for performing a demodulation method for magnetic data in accordance with an embodiment of the present invention. In this embodiment, a magnetic data reading device is a card reader 1. Therefore, FIG. 1(a) shows a principal mechanical structure of the card reader 1 and FIGS. 1(b) shows a principal electrical structure of the card reader 1.

In FIG. 1(a), the card reader 1 is provided with a shutter 10 for opening/closing a card insertion port to take a magnetic card 20 into a card feeding path. When a magnetic card 20 is inserted during the shutter 10 at the card insertion port is in an opened state, power from a motor 12 is transmitted to drive rollers 13 through a pulley 14 and a belt 15 to rotate the drive rollers 13 and thus the magnetic card 20 is taken and carried. A sensor (not shown) such as an optical sensor, which is capable of detecting a magnetic card 20 being taken in from the card insertion port, is disposed near the card insertion port.

Magnetic data on the magnetic card 20 which is carried into the inside of the card reader 1 are read out by a magnetic head 11. In other words, the magnetic head 11 contacts with a magnetic stripe and relatively slides on the magnetic stripe on a surface of the magnetic card 20 to perform reading of the magnetic data. The magnetic data which are read out are sent to a reproducing circuit 32 shown in FIG. 1(b).

As shown in FIG. 1(b), an electrical structure of the card reader 1 includes a CPU 31, the reproducing circuit 32, a ROM (Read Only Memory) 33 and a RAM (Random Access Memory) 34.

The reproducing circuit 32 has a function to form a digital signal from magnetic data (analog signal) which are read. For example, the reproducing circuit 32 is structured of a band pass filter BPF, an amplifier such as an OP amp, a capacitor and the like, a differential circuit, an integration circuit, a comparator and the like. Only an analog signal having a frequency with a specified bandwidth is passed through the band pass filter BPF to remove a high frequency noise from the analog signal. Further, the amplitude of the analog signal where the high frequency noise has been removed is amplified by the amplifier. In addition, peak points or zero crossing points of the analog signal whose amplitude has been amplified are detected by the differential circuit or the integration circuit and then, on the basis of the peak points or the zero crossing points, a digital signal in which a Hi-level and a Lo-level are alternately changed is generated.

Next, the digital signal generated in the reproducing circuit 32 is transferred to the CPU 31. The CPU 31 that receives this digital signal stores inversion time intervals of the digital signal to the RAM 34 as time data. After carrying of the magnetic card 20 has finished, the time data stored in the RAM 34 are read out to generate bit data.

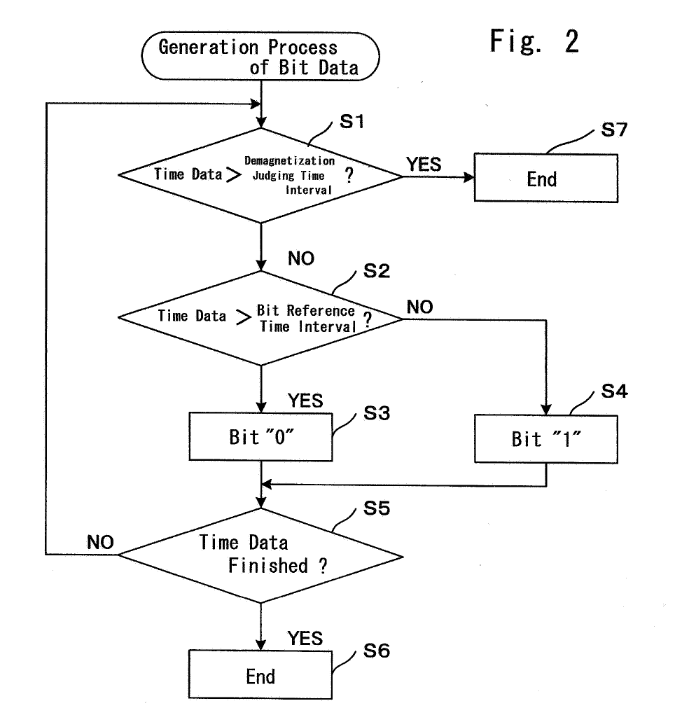

Generating process of the bit data will be described in detail with reference to FIG. 2. FIG. 2 is a flow chart for explaining a demodulation method for magnetic data in accordance with an embodiment of the present invention.

In FIG. 2, first of all, time data are compared with a demagnetization judging time interval (step S1). More specifically, the CPU 31 reads out time data which are an inversion time interval of the digital signal from the RAM 34 and refers to the demagnetization judging time interval which is previously stored in the ROM 33 to judge whether the time data are larger than the demagnetization judging time interval or not. In this embodiment, demagnetization is regarded as a typical cause of “bit lacking” and thus the time interval for detecting the “bit lacking” is referred to as the “demagnetization judging time interval”. However, a cause of “bit lacking” may be anything including demagnetization, a circuit malfunction or the like and thus “bit lacking judging time interval” is preferably set on the basis of the causes of “bit lacking” to be detected. The “demagnetization judging time interval”, the “bit lacking judging time interval” and the like are collectively referred to as “bit lacking reference time interval”.

When the time data are judged to be smaller than the demagnetization judging time interval by the CPU 31 (step S1: NO), the time data are compared with the bit reference time interval (step S2). More specifically, the CPU 31 refers to the bit reference time interval which is previously stored in the ROM 33 to judge whether or not the time data, which are read out from the RAM 34, is larger than the bit reference time interval which is used to judge the bit to be “0” or “1”. In this case, when the time data are larger than the bit reference time interval (step S2: YES), the time data are decided to be bit “0” (step S3) and, when the time data are smaller than the bit reference time interval (step S2: NO), the time data are decided to be bit “1” (step S4).

After that, the CPU 31 judges whether or not judgments on all time data have finished (step S5) and, when not finished, processes of the step S1 through the step S5 are repeated. When judgments for all time data have finished, generating processes of the bit data are finished (step S6). After that, data characters of the track in the magnetic stripe are formed from the generated bit data and error detection of the data characters is performed to determine whether the read magnetic data are correct or not. The determination result is transferred as a response to a host device (ATM, for example) and, in this manner, demodulation of the magnetic data is finished.

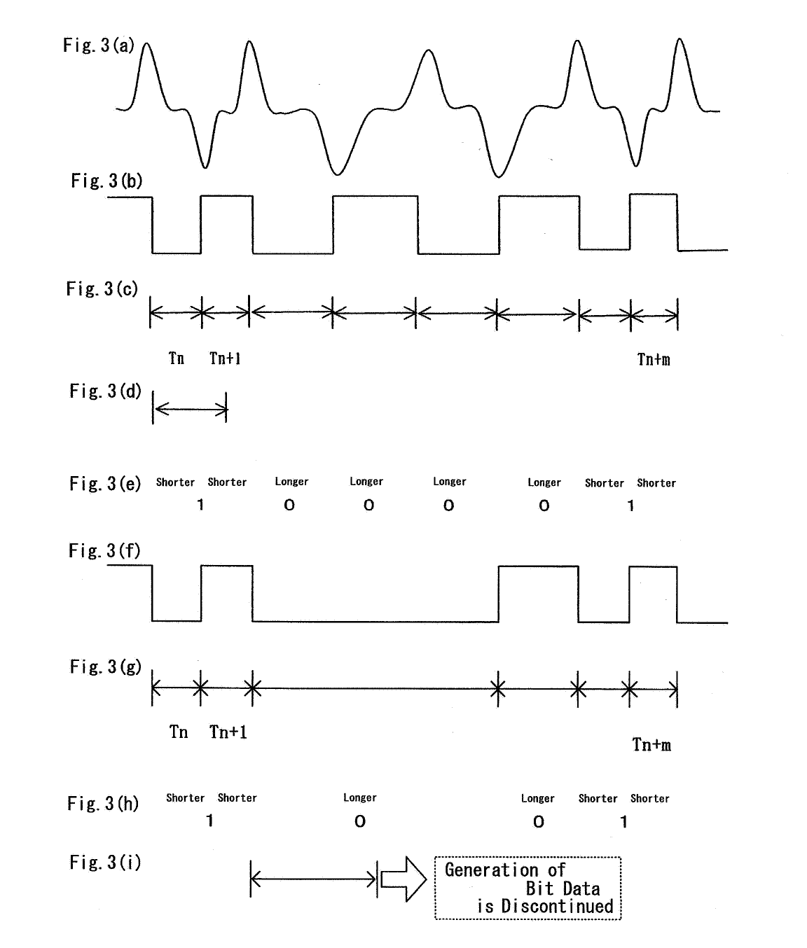

In the demodulation method for magnetic data in accordance with an embodiment of the present embodiment, in the process of the step S1 in FIG. 2, when time data are judged to be larger than the demagnetization judging time interval (step S1: YES), in other words, when the inversion time interval of the digital signal is longer than the bit lacking reference time interval, generation of the bit data is discontinued (step S7). Especially, the step S7 is performed before the inversion time interval of the digital signal is compared with the bit reference time interval, i.e., before the step S2. Further, when the inversion time interval of the digital signal is shorter than the bit lacking reference time interval (step S1: NO), the inversion time interval of the digital signal is compared with the bit reference time interval. Process from the step S1 to the step S7 will be described below with reference to FIG. 3.

FIGS. 3(a) through 3(i) are explanatory views for explaining demodulation method for magnetic data in accordance with an embodiment of the present invention. FIG. 3(a) shows a magnetic data (analog) signal which is read out by the magnetic head 11. FIG. 3(b) shows a digital signal which is generated in the reproducing circuit 32. FIG. 3(c) shows time data which are stored in the RAM 34. FIG. 3(d) shows a bit reference time interval which is previously stored in the ROM 33. FIG. 3(e) shows bit data which are generated correctly. FIG. 3(f) shows a digital signal in which abnormality occurs due to demagnetization. FIG. 3(g) shows time data which are stored in the RAM 34 on the basis of the digital signal shown in FIG. 3(f). FIG. 3(h) shows bit data which are generated on the basis of the time data shown in FIG. 3(g). FIG. 3(i) shows a demagnetization judging time interval which is previously stored in the ROM 33. In FIG. 3(i), the demagnetization judging time interval is set to be a constant value of about 1.5 times of the bit reference time interval but the present invention is not limited to this embodiment. For example, when the bit reference time interval is varied based on a magnetic card carrying speed, it is preferable that the demagnetization judging time interval (bit lacking reference time interval) is also varied. As described above, a time interval which is about 1.5 times of the time interval corresponding to the bit “0” in conformity with recording characteristics of a track in a magnetic stripe is utilized as the demagnetization judging time interval and thus bit lacking is detected with a high degree of accuracy.

As shown in FIG. 3(a), magnetic data (analog signal) comprised of combination of two kinds of frequencies of “F” and “2F” are read out by the magnetic head 1. The analog signal is converted into the digital signal shown in FIG. 3(b) by the reproducing circuit 32, and time data (Tn, Tn+1, . . . ) on the basis of the digital signal which are shown in FIG. 3(c) are stored in the RAM 34. After that, the time data shown in FIG. 3(c) are compared with the bit reference time interval shown in FIG. 3(d) by the CPU 31 and, when time data are shorter than the bit reference time interval, in other words, when inversion of the time data is occurred within the bit reference time interval, the time data are judged as bit “1”, and when inversion is not occurred, the time data are judged as bit “0”. As a result, correct bit data “100001” (six digits) are obtained (see FIG. 3(e)).

However, when abnormality occurs in a digital signal due to demagnetization, for example, as shown in the center portion of FIG. 3(f), the time data stored in the RAM 34 are obtained as shown in FIG. 3(g). As a result, incorrect bit data “l 1001” (four digits) will be generated (see FIG. 3(h)) on the basis of the bit reference time interval shown in FIG. 3(d). In addition, for example, when data of “00” will be succeeded after these bit data “1001”, “100100” (six digits) are generated to judge as one piece of bit data. Accordingly, the bit data of the 6 digits which include these incorrect bit data “1001” will be erroneously generated as correct bit data.

On the contrary, in a demodulation method in accordance with an embodiment of the present embodiment, the demagnetization judging time interval shown in FIG. 3(i) is previously stored in the ROM 33. In addition, the CPU 31 compares the time data shown in FIG. 3(g) with the demagnetization judging time interval shown in FIG. 3(i) before comparing with the bit reference time interval shown in FIG. 3(d) (see step S1 and step S2 in FIG. 2). According to the demodulation method in accordance with the embodiment described above, since the time data shown in FIG. 3(g) include longer data than the demagnetization judging time interval shown in FIG. 3(i), generation of bit data is discontinued (see step S1→step S7 in FIG. 2).

As described above, according to the demodulation method for magnetic data in accordance with the embodiment, incorrect judgment is prevented that data in a track have been read out correctly although they have wrong bit data, and thus demodulation accuracy can be enhanced. Further, since generation of incorrect bit data is discontinued, processing time is reduced. In addition, as shown in FIG. 2, the process of the step S1 is carried out before the process of the step S2 and thus waste is prevented in which bit data are generated from abnormal digital signal.

When the card reader 1 has received a reading command from its host device and data on a magnetic stripe have been read out, in a case that abnormal data are detected, the card reader 1 commonly returns an abnormality notice to the host device. The abnormality notice may include abnormality contents to inform which portion of data on the magnetic stripe has abnormality. The abnormality contents may include, for example, start code is not detected, end code is not detected, parity check is abnormally detected, LRC characters are not detected, and a wrong LRC character is detected. Therefore, when an abnormality content in which demagnetization is occurred in the magnetic data is added to these contents, abnormality content of magnetic data can be informed to the host device.

The demodulation method for magnetic data in accordance with an embodiment of the present invention is effectively applicable to enhance demodulation accuracy.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A demodulation method for magnetic data comprising the steps of:
reading magnetic data recorded on a magnetic recording medium with a magnetic head to produce an analog signal;
generating a digital signal from the analog signal;
comparing an inversion time interval of the digital signal with a bit reference time interval; and
generating bit data on a basis of comparing result of the digital signal;
wherein the demodulation method for magnetic data further comprises:
a first step of comparing the inversion time interval of the digital signal with a bit lacking reference time interval which is set to be longer than the bit reference time interval; and
a second step of discontinuing generation of the bit data when the inversion time interval of the digital signal is detected to be longer than the bit lacking reference time interval in the first step.

2. The demodulation method for magnetic data according to claim 1, wherein the first step is executed before the inversion time interval of the digital signal is compared with the bit reference time interval.

3. The demodulation method for magnetic data according to claim 2, wherein the second step is executed before the inversion time interval of the digital signal is compared with the bit reference time interval.

4. The demodulation method for magnetic data according to claim 2, wherein in the first step, when the inversion time interval of the digital signal is shorter than the bit lacking reference time interval, the inversion time interval of the digital signal is compared with the bit reference time interval.

5. The demodulation method for magnetic data according to claim 1, wherein the bit lacking reference time interval is set to be about 1.5 times of a time interval which corresponds to a bit “0”.

6. The demodulation method for magnetic data according to claim 5, wherein the bit lacking reference time interval is set to detect demagnetization or reduced magnetization of data on the magnetic stripe.

7. A demodulation method for magnetic data comprising the steps of:
reading magnetic data recorded on a magnetic recording medium with a magnetic head to produce an analog signal;
generating a digital signal from the analog signal;
comparing an inversion time interval of the digital signal with a bit reference time interval for judging bits “0” and “1”; and
generating bit data comprised of the bits “0” and “1” on a basis of a result of the comparing of the digital signal;
wherein the demodulation method for magnetic data further comprising the steps of:
previously setting a bit lacking reference time interval, which is longer than the bit reference time interval, for judging a bit lacking in the digital signal;
comparing the inversion time interval of the digital signal with the bit lacking reference time interval; and then
when the inversion time interval of the digital signal is longer than the bit lacking reference time interval, the step of comparing the inversion time interval of the digital signal with the bit reference time interval is discontinued.

8. The demodulation method for magnetic data according to claim 7, wherein
comparing one of subsequent inversion time intervals of the digital signal with the bit lacking reference time interval; and after that,
when the inversion time interval is shorter than the bit lacking reference time interval, comparing the one of the subsequent inversion time intervals with the bit reference time interval to judge bits “0” and “1”, and then, comparing next one of subsequent inversion time intervals of the digital signal with the bit lacking reference time interval; and alternatively,
when the one of the subsequent inversion time interval is longer than the bit lacking reference time interval, discontinuing the step of comparing the one of the subsequent inversion time intervals of the digital signal with the bit reference time interval, and then discontinuing comparing next one of subsequent inversion time intervals of the digital signal with both of the bit lacking reference time interval and the bit reference time interval.

9. The demodulation method for magnetic data according to claim 7, wherein the bit lacking reference time interval is set to be about 1.5 times of a time interval which corresponds to the bit “0”.
